(19) United States
(12) Patent Application Publication
(10) Pub. No.: US 2026/0274591 A1
(43) Pub. Date: Sep. 17, 2026

(54) ELECTROMAGNETIC STOPPER, IN PARTICULAR FOR STOPPING, SEPARATING, POSITIONING AND HOLDING OBJECTS ON A TRANSPORT ROUTE

(71) Applicant: Kendrion (Donaueschingen/Engelswies) GmbH, Donaueschingen (DE)

(72) Inventor: Oliver WICKBOLDT, Malente (DE)

(21) Appl. No.: 19/558,830

(22) Filed: Mar. 6, 2026

(30) Foreign Application Priority Data
Mar. 12, 2025 (DE) 102025109522.1

(51) Int. Cl. B65G 47/82; F16H 21/44

(52) U.S. Cl. CPC B65G 47/82; F16H 21/44; B65G 2811/0668

(57) ABSTRACT

An electromagnetic stopper includes a housing and a first lever arm and a third lever arm arranged on the housing so as to be pivotable via a first joint and a third joint, respectively. A second lever arm is arranged on the first lever arm so as to be pivotable via a first connecting joint and is arranged on the third lever arm so as to be pivotable via a third connecting joint. An actuator is mechanically connected to the first lever arm or the second lever arm, and can be moved between a stop position and an open position. A stop element arranged on the third lever arm protrudes at least partially from the housing in the stop position. The third joint has a third joint axis and the third connecting joint has a third connecting joint axis spaced apart from the third joint axis.

The invention relates to an electromagnetic stopper, in particular for stopping, separating, positioning and holding objects on a transport route, according to the features of claim 1.

Electromagnetic stoppers are frequently used in automated assembly lines in factory and process automation, as well as in sorting and logistics systems, to stop, separate, position or hold objects, in particular workpiece carriers, on the transport route.

Electromagnetic stoppers have been known in the prior art for some time. A disadvantage of existing electromagnetic stoppers is that they are specialized solutions for specific applications and therefore do not offer modularity within a product range without having to completely redesign the electromagnetic stopper. Furthermore, the complicated design, especially when using damping elements, leads to higher assembly complexity and therefore to higher overall costs. Similarly, the more complicated structures of previous electromagnetic stoppers lead to a higher susceptibility to errors during operation.

These problems are solved using an electromagnetic stopper having the features of claim 1.

Advantageous embodiments and developments of the invention are specified in the dependent claims.

An electromagnetic stopper, in particular for stopping or separating objects on a transport route, is therefore inventive and comprises: a housing; a first lever arm and a third lever arm, wherein on the housing the first lever arm is arranged so as to be pivotable via a first joint and the third lever arm is arranged so as to be pivotable via a third joint; a second lever arm, wherein the second lever arm is arranged on the first lever arm so as to be pivotable via a first connecting joint and is arranged on the third lever arm so as to be pivotable via a third connecting joint; an actuator which is mechanically connected to the first lever arm or to the second lever arm and can be moved between a stop position and an open position; a stop element, which, in the stop position, protrudes at least partially from the housing; the stop element is arranged on the third lever arm, wherein the third joint has a third joint axis and the third connecting joint has a third connecting joint axis, wherein the third joint axis and the third connecting joint axis are spaced apart from each other.

One advantage of these spaced apart joint axes is that the resulting lever mechanism allows for a simple design to move the stop element between the stop position and the open position. A greater distance between the joint axes reduces the required deflection of the actuator and thus increases the mechanical stability of the entire electromagnetic stopper.

The invention is based on the concept that the third lever arm is easy to assemble and disassemble, the stop element and preferably a damping element being arranged on the third lever arm. Depending on the application, the corresponding lever arm can then be exchanged cost-effectively.

Furthermore, the invention is based on the idea of making the mechanical design of the electromagnetic stopper as simple as possible in order to reduce susceptibility to errors and to minimize exchangeability, in particular of the third lever arm.

The longitudinal axis of the electromagnetic stopper is preferably defined as the axis that runs parallel to the transport direction of the object on the transport route.

The vertical axis of the electromagnetic stopper is preferably defined as the axis that intersects the transport route and the longitudinal axis perpendicularly.

The transverse axis of the electromagnetic stopper is preferably defined as the axis that intersects the longitudinal axis and the vertical axis perpendicularly.

Advantageously, the first connecting joint and the third connecting joint are linearly movable in two spatial directions. Furthermore, the first connecting joint and the third connecting joint allow translational movement of the second lever arm. This allows the second lever arm to move at least partially freely within the housing of the electromagnetic stopper. The linear movement preferably occurs in the direction of the longitudinal axis and the vertical axis. The resulting high mobility of the second lever arm virtually eliminates the possibility of it jamming against other components of the electromagnetic stopper. Furthermore, with such a configuration, the design of the electromagnetic stopper is particularly simple.

Preferably, the stop element and the third lever arm are formed in one piece. This allows the third lever arm and the stop element to be manufactured from a single piece, which is particularly cost-effective and easy to assemble. Furthermore, the single-piece design reduces the number of components, in particular in the region of the transport route, and this facilitates use in harsh environments.

According to one advantageous further development of the invention, the stop element is arranged on the third lever arm so as to be pivotable via a fourth joint. The pivoting motion allows the object to follow its direction over a specified distance upon impact with the stop element, thus at least partially absorbing the impact of the object. This prevents damage to the object.

According to one particularly preferred embodiment of the invention, the third joint, the third connecting joint and the fourth joint have joint axes spaced apart from each other. The distance between the fourth joint and the third joint is preferably greater than the distance between the fourth joint and the third connecting joint. The ratio of these distances is preferably two to six times. The fourth joint is preferably arranged at one end of the third lever arm, the third joint being arranged at the other end of the third lever arm. The third connecting joint is arranged therebetween.

A damping element is advantageously arranged on or within the third lever arm. The movable region of the damping element rests directly against the stop element. The damping element can be arranged in a cavity in the third lever arm. The damping element can be designed in the form of a mechanical damping element, in particular a spring damping element or a rubber damping element. The damping element can also have hydraulic, pneumatic, or magnetic damping. The damping element is installed directly inside or on the third lever arm. The advantage of this is that the damping element does not require its own pivoting mechanism in the form of a separate joint. This significantly reduces the assembly complexity. Furthermore, exchanging the third lever arm enables a high degree of modularity and configurability. The advantage of the damping element is that the kinetic energy of the object on the transport route is gently absorbed by the damping element.

Preferably, the stop element has a first free end and a second free end, wherein, in the stop position, the first free end protrudes from the housing and the second free end rests directly against the damping element, preferably against the movable region of the damping element. In the stop position, the first free end comes into contact with the object. The design is therefore kept very simple. In particular, the damping element does not need to be mechanically fixedly connected to the stop element, e.g., using an additional joint; this reduces the assembly complexity and permits tolerances.

According to one particularly advantageous further development of the invention, the electromagnetic stopper has the longitudinal axis which extends parallel and in the direction of a transport route, wherein the part of the actuator connected to the first lever arm or to the second lever arm can be moved parallel in the direction of the longitudinal axis. The actuator, which can assume a larger spatial extent, is preferably arranged parallel to the third lever arm. Since the third lever arm, as explained above, also preferably has a certain length, this results in a more compact design of the electromagnetic stopper. The actuator can also be arranged parallel to the vertical axis or the transverse axis.

According to one advantageous further development of the invention, an imaginary third auxiliary line, which intersects the third joint and the fourth joint, and preferably the third connecting joint, in the stop position, runs almost parallel to the longitudinal axis of the electromagnetic stopper. The imaginary third auxiliary line can be placed through the center of the joint. The advantage is that the extent of the electromagnetic stopper can be designed to be more compact along the vertical axis.

Advantageously, in the stop position a first distance, which is the distance between the third joint axis of the third joint and the third connecting joint axis of the third connecting joint, is approximately equal to a second distance, which is the distance between the third connecting joint axis and a first joint axis of the first joint. This makes it possible to implement the electromagnetic stopper in an extremely compact manner. Furthermore, the individual levers of the respective lever arms are optimally utilized.

Preferably, the actuator is in the form of an electromagnetic actuator. The actuator can also be a pneumatic or hydraulic actuator. Electromagnetic actuators have long been used in stoppers and have proven effective.

According to one particularly preferred embodiment of the invention, the electromagnetic stopper is longer in the longitudinal axis than in the vertical axis. The space in the direction of movement of the object on the transport route is often hardly limited due to the greater transport distances. The electromagnetic stopper can also be the same length in the longitudinal axis as in the vertical axis. The electromagnetic stopper can also be shorter in the longitudinal axis than in the vertical axis.

Two exemplary embodiments of the present invention are described in detail below with reference to the accompanying drawings, in which:

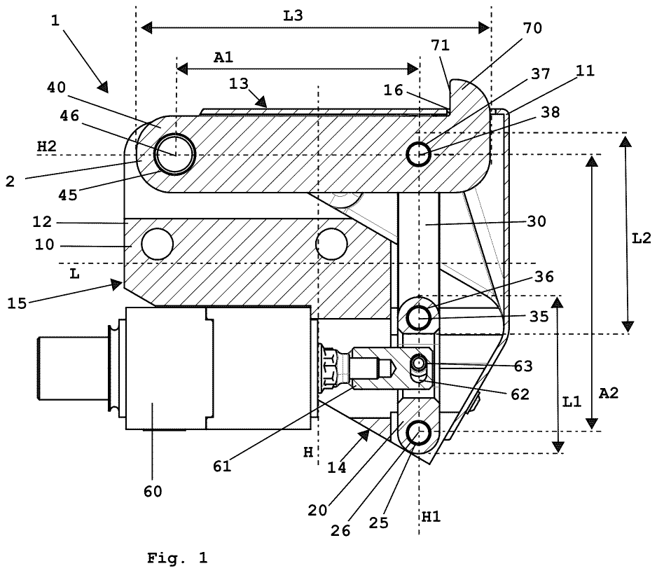

FIG. 1 shows a longitudinal section of an electromagnetic stopper without a damping element, and,

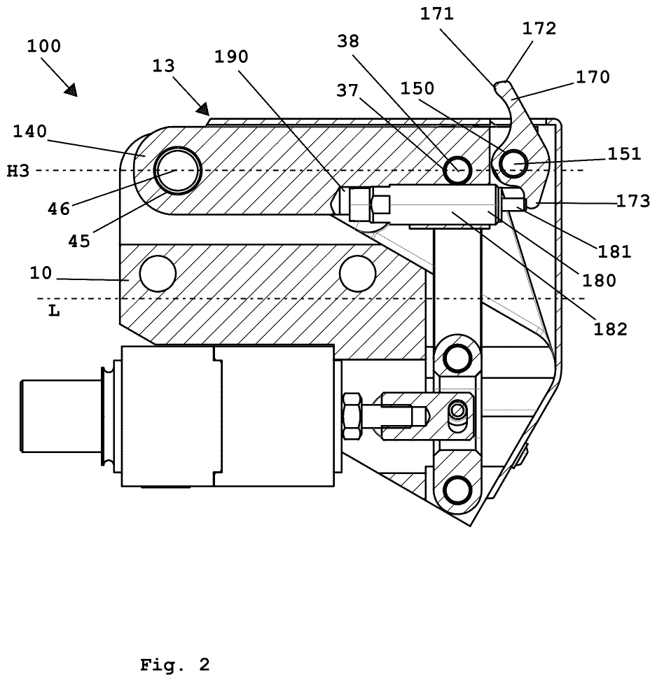

FIG. 2 shows a longitudinal section of an electromagnetic stopper having a damping element and a stop element pivotably arranged on the third lever arm.

Identical or functionally identical parts or features are identified by the same reference symbols in the following detailed description of the figures. Likewise, not all identical or functionally identical parts or features in the figures are provided with a reference number.

FIG. 1 shows a longitudinal section of an electromagnetic stopper 1. The electromagnetic stopper 1 is positioned along a transport route (not visible) to stop, separate, position or hold objects (not visible) that are transported on the transport route.

The electromagnetic stopper 1 can be transferred from a stop position to an open position and vice versa. FIG. 1 shows the electromagnetic stopper 1 in the stop position.

The electromagnetic stopper 1 has a longitudinal axis L, a transverse axis (not shown) and a vertical axis H.

The electromagnetic stopper 1 comprises a housing 10, an electromagnetic actuator 60, a lever system 2 and a stop element 70.

The housing 10 has a top 13, a bottom 14 and a side wall 15. The top 13 is arranged closest to the transport route, the bottom 14 being arranged opposing the top 13.

The housing 10 is designed in two parts and has a first housing part 11, which is preferably a cover, and a second housing part 12, which is preferably a base block. The housing 10 can also be designed as a single part or multiple parts.

The first housing part 11, which is preferably the cover, is made of plastic. The first housing part 10 can also be made of aluminum, steel or another material.

The second housing part 12, which is preferably the base block, is made of aluminum. The second housing part 12 can also be made of plastic, steel or another material.

The first housing part 11 and the second housing part 12 are mechanically connected, in particular screwed, to each other. The screw connection allows for easy assembly and disassembly of the first housing part 11 from the second housing part 12. The first housing part 11 and the second housing part 12 can also be grooved, clamped, glued or otherwise mechanically connected to each other.

The top 13 of the housing 10 is at least partly formed by the first housing part 11. The bottom 14 of the housing 10 is formed by the second housing part 12.

The lever system 2 is arranged inside the housing 10. The electromagnetic actuator 60 is at least partly arranged inside the housing 10. The electromagnetic actuator 60 is arranged parallel to the longitudinal axis L of the electromagnetic stopper 1.

The electromagnetic actuator 60 has an adapter 61 which can be moved linearly. Preferably, the adapter 61 moves along the longitudinal axis L of the electromagnetic stopper 1.

The electromagnetic actuator 60 can have a control unit (not visible). The control unit can be installed inside the electromagnetic actuator 60. The control unit communicates with a higher-level control system (not visible) that controls the overall system of the transport route. The electromagnetic actuator 60 can also receive commands directly from a higher-level control unit.

The electromagnetic actuator 60 can be replaced by any other actuating device suitable for exerting a force on one of the lever arms 20, 30, 40, so that the stop element 70 can be transferred from the stop position to the open position and vice versa.

The electromagnetic actuator 60, in particular the adapter 61 of the electromagnetic actuator 60, is mechanically coupled to the lever system 2.

The adapter 61 has an elongated hole 62 into which a first lever arm 20 engages with a pin 63 and mechanically connects the electromagnetic actuator 60 to the first lever arm 20. The adapter 61 can be mechanically connected to any other lever arm 30, 40.

The lever system 2 comprises the first lever arm 20, a second lever arm 30 and a third lever arm 40.

The first lever arm 20, the second lever arm 30 and the third lever arm 40 are rod-shaped, the ends of the first lever arm 20 and the ends of the second lever arm 30 being rounded. At least one end of the third lever arm 40 is also rounded.

The first lever arm 20 is arranged on the housing 10 so as to be pivotable at one end of said arm via a first joint 25 near the bottom 14 of the housing 10. The first lever arm 20 has a length L1. The first lever arm can only perform a rotational movement since it is fixedly connected to the housing 10.

The third lever arm 40 is arranged on the housing 10 so as to be pivotable at one end of said arm via a third joint 45 near the top 13 of the housing 10. The third lever arm 40 has a length L3. The third lever arm can only perform a rotational movement since it is fixedly connected to the housing 10.

The second lever arm 30 is arranged on the first lever arm 20 so as to be pivotable at one end of the second lever arm via a first connecting joint 35. The second lever arm 30 is arranged on the third lever arm 40 so as to be pivotable at a different end via a third connecting joint 37. The second lever arm 30 has a length L2. The second lever arm 30 can perform a rotational movement. Furthermore, the second lever arm 30 can perform a translational movement in two spatial directions depending on the first lever arm 20 and the second lever arm 30.

The length L1 of the first lever arm is smaller than the length L2 of the second lever arm 30. The length L3 of the third lever arm 40 is greater than the length L2 of the second lever arm 30. The total length of the length L1 of the first lever arm 20 and the length L2 of the second lever arm 30 is roughly the same as the length L3 of the third lever arm 40.

The second lever arm 30 is approximately one and a half times longer than the first lever arm 20. The third lever arm 40 is approximately one and a half times longer than the second lever arm 30.

The length L1 of the first lever arm 20 can also be longer than the length L2 of the second lever arm 30 or the length L3 of the third lever arm 40. The length L2 of the second lever arm 30 can also be longer than the length L1 of the first lever arm 20 or the length L3 of the third lever arm 40.

The first joint 25, the third joint 45, the first connecting joint 35 and the third connecting joint 37 are preferably designed as rotational joints. The first joint 25, the third joint 45, the first connecting joint 35 and the third connecting joint 37 can also be designed as ball joints or other types of joints.

In the stop position, a first distance A1, which is the distance between the third joint axis 46 of the third joint 45 and the third connecting joint axis 38 of the third connecting joint 37, is roughly equal to a second distance A2, which is the distance between the third connecting joint axis 38 and a first joint axis 26 of the first joint 25. The first distance A1 can also be one to three times greater than the second distance A2. The first distance A1 can also be one to three times less than the second distance A2.

In the stop position, the first joint 25, the first connecting joint 35, the third connecting joint 37, in particular the respective joint axes 26, 36, 38, are aligned with each other along a first imaginary auxiliary line H1, the first imaginary auxiliary line H1 being parallel to the vertical axis H of the electromagnetic stopper 1. The first imaginary auxiliary line H1 can form an angle to the longitudinal axis L of the electromagnetic stopper 1 of preferably 90±x degrees, where x is less than or equal to 15 degrees.

In the stop position, the third joint 45 and the third connecting joint 37, in particular their joint axes 38, 46, are aligned with each other along a second imaginary auxiliary line H2. The second imaginary auxiliary line H2 is arranged parallel to the longitudinal axis L of the electromagnetic stopper 1. The second imaginary auxiliary line H2 can also form an angle to the vertical axis H of the electromagnetic stopper 1 of preferably 90±y degrees, where y is less than or equal to 15 degrees.

In the stop position, the first imaginary auxiliary line H1 and the second imaginary auxiliary line H2 preferably intersect at a right angle. The advantage of this is that the electromagnetic stopper can be of extremely compact design. The first imaginary auxiliary line H1 and the second imaginary auxiliary line H2 can also form an angle to each other that is different from 90 degrees. This angle preferably has an angle between 75 and 105 degrees.

In the open position, the first lever arm 20 and the second lever arm 30 form an angle of between 90 and 145 degrees to each other. Preferably, the first lever arm 20 and the second lever arm 30 form an angle of 120 to 130 degrees to each other in the open position. The first lever arm 20 and the second lever arm 30 can also form other angles to each other in the open position.

In the open position, the second lever arm 30 and the third lever arm 40 form an angle of between 90 and 145 degrees. Preferably, the second lever arm 30 and the third lever arm 40 form an angle of 120 degrees to each other. The second lever arm 30 and the third lever arm 40 can also form other angles to each other in the open position.

The stop element 70 is arranged on the third lever arm 40. The stop element 70 and the third lever arm 40 are formed in one piece. In particular, the stop element 70 and the third lever arm 40 are manufactured from one workpiece.

The stop element 70 has a stop side 71. The stop side 71 of the stop element 70 and the third lever arm 40 form a right angle. The stop side of the stop element 70 and the third lever arm 30 can also have a continuous, rounded or unwound transition.

The stop element 70 is located behind the third connecting joint 37 from the perspective of the third joint 45.

The transfer of the electromagnetic stopper 1 from the stop position to the open position is initiated by a corresponding command to the electromagnetic actuator 60. The adapter 61 of the electromagnetic actuator 60 moves parallel to the longitudinal axis L of the electromagnetic stopper 1. The direction of movement of adapter 61 is the direction of movement of the object on the transport route. The direction of movement of adapter 61 can also be in opposition to the direction of movement of the object on the transport route. The adapter 61 can also have a completely different direction of movement.

The adapter 61 is mechanically connected to the first lever arm 20. The first lever arm 20 absorbs the movement of the adapter 61. The first lever arm 20 then performs a rotational movement, which causes the second lever arm 30 to tilt towards the bottom 14 of the housing 10 and in the same direction as the direction of movement of the adapter 61.

The second lever arm 30, which is mechanically connected to the third lever arm 40 via the third connecting joint 37, causes the third lever arm 40 to tilt towards the bottom 14 of the housing 10.

In the stop position, the stop element 70 protrudes from an opening 16 in the housing 10 into the transport route. In the stop position, the tilting of the third lever arm 40 causes the stop element 70 to be withdrawn completely into the housing 10.

FIG. 2 shows a second exemplary embodiment of an electromagnetic stopper 100 with a damping element 180 and with a stop element 170 pivotably arranged on a third lever arm 140.

The electromagnetic stopper 100 is constructed identically to the electromagnetic stopper 1 from the exemplary embodiment shown in FIG. 1, except for the damping element 180 and the pivotable stop element 170. Therefore, reference is made to the foregoing, and only the new features are described.

The third lever arm 140 has a cavity 190. The damping element 180 is arranged inside the cavity 190 and is mechanically connected to the third lever arm 140. The damping element 180 can be screwed, clamped, glued or otherwise mechanically connected to the third lever arm 140. The damping element 180 can also be arranged on the third lever arm 140.

The damping element 180 is in the form of a mechanical damping element. The mechanical damping element 180 has a spring element (not visible) having a restoring force. The damping element 180 can also have a rubber or hydraulic or pneumatic damping.

The damping element 180 has a protective housing 182 in which the spring element is arranged. The protective housing 182 protects the spring element from environmental influences. The damping element 180 has a movable region 181 which is connected in a force-fit to the spring element and is arranged at least partly outside the housing 10.

A stop element 170 is arranged on the third lever arm 140. The stop element 170 is pivotably arranged on the third lever arm 140 via a fourth joint 150. The fourth joint 150 is located behind the third connecting joint 37 from the perspective of the third joint 45.

The stop element 170 has a single fourth joint axis 151 about which the stop element 170 can pivot. This makes the connection of the stop element 170 to the third lever arm 140 particularly simple.

The fourth joint 150 is the same as, or can be the same as, the joints in the first exemplary embodiment.

The third joint 45, the third connecting joint 37 and the fourth joint 150 having a fourth joint axis 151 have joint axes 38, 46, 151 spaced apart from each other. The fourth joint axis 151 is arranged closer to the top 13 of the housing 10 than all other joint axes.

A third imaginary auxiliary line H3, which intersects the third joint 45 and the fourth joint 150, and preferably the third connecting joint 37, in the stop position, extends almost parallel to or parallel to the longitudinal axis L of the electromagnetic stopper 1.

The stop element 170 has a first free end 172 and a second free end 173, wherein the first free end 172, in the stop position, protrudes from the housing 10 and the second free end 173 rests directly against the damping element 180, preferably against the movable region 181 of the damping element 180. This eliminates the need for a mechanical connection between the damping element 180 and the stop element 170 during the assembly process, resulting in a significant time saving.

The first free end 172 forms a stop side 171 on the stop element 170, against which an object is securely held in a stop position.

The first exemplary embodiment shown in FIG. 1 can be easily transformed into the second exemplary embodiment shown in FIG. 2 by exchanging the third lever arm 40; 140. All changes between the first and second exemplary embodiments are directly linked to the third lever arm 40; 140. This results in a high degree of modularity of the electromagnetic stopper 1; 100 due to the easy exchangeability of the third lever arm 40; 140, which reduces production costs and increases flexibility in relation to customer orders.

### LIST OF REFERENCE SYMBOLS

1 Electromagnetic stopper
2 Lever system
10 Housing
11 First housing part
12 Second housing part
13 Top
14 Bottom
15 Side wall
16 Opening
20 First lever arm
25 First joint
26 First joint axis
30 Second lever arm
35 First connecting joint
36 First connecting joint axis
37 Third connecting joint
38 Third connecting joint axis
40 Third lever arm
45 Third joint
46 Third joint axis
60 Actuator
61 Adapter
62 Elongated hole
63 Pin
70 Stop element
71 Stop side
100 Electromagnetic stopper
140 Third lever arm
150 Fourth joint
151 Fourth joint axis
170 Stop element
171 Stop side
172 First free end
173 Second free end
180 Damping element
181 Movable region
182 Protective housing
L Longitudinal axis
H Vertical axis
H1 First auxiliary line
H2 Second auxiliary line
H3 Third auxiliary line
A1 First distance
A2 Second distance
L1 Length of first lever arm
L2 Length of second lever arm
L3 Length of third lever arm

1. An electromagnetic stopper (1; 100), in particular for separating, positioning and/or holding objects on a transport route, comprising:
a housing (10),
a first lever arm (20) and a third lever arm (40; 140), wherein on the housing (10) the first lever arm (20) is arranged so as to be pivotable via a first joint (25) and the third lever arm (40; 140) is arranged so as to be pivotable via a third joint (45),
a second lever arm (30), wherein the second lever arm (30) is arranged on the first lever arm (20) so as to be pivotable via a first connecting joint (35) and is arranged on the third lever arm (40) so as to be pivotable via a third connecting joint (37),
an actuator (60) which is mechanically connected to the first lever arm (20) or to the second lever arm (30), and can be moved between a stop position and an open position, and
a stop element (70; 170) which, in the stop position, protrudes at least partially from the housing (10),
characterized in that
the stop element (70; 170) is arranged on the third lever arm (40; 140), and
wherein the third joint (45) has a third joint axis (46) and the third connecting joint (37) has a third connecting joint axis (38), wherein the third joint axis (46) and the third connecting joint axis (38) are spaced apart from each other.

2. The electromagnetic stopper (1; 100) according to claim 1, characterized in that the first connecting joint (35) and the third connecting joint (37) are linearly movable in two spatial directions.

3. The electromagnetic stopper (1; 100) according to claim 1, characterized in that the stop element (70) and the third lever arm (40) are formed in one piece.

4. The electromagnetic stopper (1; 100) according to claim 1, characterized in that the stop element (170) is arranged on the third lever arm (140) so as to be pivotable via a fourth joint (150).

5. The electromagnetic stopper (1; 100) according to claim 1, characterized in that the third joint (45), the third connecting joint (37) and the fourth joint (150) having a fourth joint axis (151) have joint axes (38, 46, 151) spaced apart from each other.

6. The electromagnetic stopper (1; 100) according to claim 1, characterized in that a damping element (180) is arranged on the third lever arm (140) or within the third lever arm (140).

7. The electromagnetic stopper (1; 100) according to claim 1, characterized in that the stop element (170) has a first free end (172) and a second free end (173), wherein the first free end (172), in the stop position, protrudes from the housing (10) and in that the second free end (173) rests directly against the damping element (180), preferably against a movable region (181) of the damping element (180).

8. The electromagnetic stopper (1; 100) according to claim 1, characterized in that the electromagnetic stopper (1; 100) has a longitudinal axis (L) which extends parallel and in the direction of a transport route, wherein the part of the actuator (60) connected to the first lever arm (20) or the second lever arm (30) can be moved parallel in the direction of the longitudinal axis (L).

9. The electromagnetic stopper (1; 100) according to claim 1, characterized in that an imaginary third auxiliary line (H3), which intersects the third joint and the fourth joint (150), and preferably the third connecting joint (37), in the stop position, extends almost parallel to the longitudinal axis (L) of the electromagnetic stopper (1; 100).

10. The electromagnetic stopper (1; 100) according to claim 1, characterized in that in the stop position a first distance (A1), which is the distance between the third joint axis (46) of the third joint (45) and the third connecting joint axis (38) of the third connecting joint (37), is approximately equal to a second distance (A2), which is the distance between the third connecting joint axis (38) and a first joint axis (26) of the first joint (25).

11. The electromagnetic stopper (1; 100) according to claim 1, characterized in that the actuator (60) is in the form of an electromagnetic actuator (60).

12. The electromagnetic stopper (1; 100) according to claim 1, characterized in that the electromagnetic stopper (1; 100) is longer in the longitudinal axis (L) than in a vertical axis (H).
